(19) United States
(12) Patent Application Publication
(10) Pub. No.: US 2026/0366513 A1
(43) Pub. Date: Nov. 19, 2026

(54) A CONTROLLER FOR CONTROLLING A PUMP UNIT

(71) Applicant: SOLAR TO WATER TECHNOLOGIES PTY LTD., Beverley (AU)

(72) Inventors: Mark Jefferson KIRTLAND, Largs North (AU); Lionel KERR, Mylor (AU)

(21) Appl. No.: 19/475,937

(22) PCT Filed: Apr. 17, 2024
(86) PCT No.: PCT/AU2024/050366

§ 371 Date: Oct. 16, 2025

(30) Foreign Application Priority Data
Apr. 17, 2023 (AU) 2023901128

(51) Int. Cl. F04D 15/02; F04D 13/06; F04D 15/00; H02P 29/024

(52) U.S. Cl. CPC F04D 15/0209; F04D 13/06; F04D 15/0088; H02P 29/024

(57) ABSTRACT

The present application relates to a controller for controlling a pump unit comprising an electric motor for moving fluid in a hydraulic application according to a predicted pressure and or flow of the pump unit.

### TECHNICAL FIELD

The present application relates to a controller for controlling a pump unit. More specifically, the present application relates to controlling the pump unit to control the movement of fluid in a hydraulic application according to a predicted pressure and or flow of the pump unit.

### BACKGROUND OF INVENTION

Pumps have long been used to perform tasks such as, but not limited to, recirculation and transfer of fluids, such as water in aquatic applications, such as pools, spa, aquaculture etc.

In one aquatic application, a typical swimming pool of 6×4 m, e.g., 6 metres long, 4 metres wide, with an average depth of 1.5m, equates to 36,000 litres. To turnover this volume in 4 hours requires a turnover rate of 150 litres per minute (lpm). While higher flowrates are better to achieve this, higher flowrates require a larger filter to accommodate this higher flowrate. Most swimming pool associations (including the World Health Organization (WHO)) globally recommend a pool water turnover rate of at least one complete volume of pool water per 24 hours. Industry standard for domestic pools is preferably within 4 to 6 hours per day.

A pressure sensor associated with a pressure gauge is generally used to indicate to a pool owner when the pressure is high, e.g., the filter is becoming blocked and full of dirt. As the flowrate drops off, the pressure rises, and a set point on the gauge indicates that it is time to clean or backflush the filter.

Accordingly, flow rate (also referred to as ‘volume’ or ‘volume of flow’) and pressure (also referred to as ‘head’ or ‘head pressure’) are two vital operational parameters with regards to the health and wellbeing of aquatic applications, such as swimming pools. Moreover, understanding where a pump operates on its pump performance curve is vital for correct operation of the pump since it directly or indirectly correlates to efficiency of the pump (by understanding how much energy is consumed by the pump), knowing whether the pump is achieving a selected duty point and/or one or more faulty conditions that can occur when the pump operates outside the desired design and/or selection parameters. Determining if the pump is in a faulty condition or approaching one is critical in avoiding costly repairs or total replacements and the associated down-time in non-usability of the pool.

Currently available systems and methods for measuring operational parameters such as pressure and flow of and for detecting faulty condition in, a pump involves use of third-party sensors. Typically, a flow meter or a flow transducer (such as a magnetic flow transducer) may be used to measure flow. A pressure gauge or a pressure transducer may be used to measure pressure, and different types of sensors may be used to measure loss of prime may be used to detect a faulty condition in the pump. In an electronic or digital form, an accurate, flow transducer that suits a pipe diameter of 50 to 80 mm for say a swimming pool adds significant expense to the pool installation. Similarly, a suitable pressure transducer adds significant expense, in addition to different types of motor current sensors to detect electrical fault conditions.

Such third-party sensors are costly, makes the pump system of the aquatic application more complex. As a result, they are not used for controlling the operation of a pump for certain applications, such as a swimming pool, spa or in aquaculture, even though strict volume turnover rate regulations are required to be met.

There is therefore a need for a more cost-effective and less complex system and controller for controlling movement of fluids in an aquatic application using hydraulic pumps that does not involve the use of such dedicated third-party sensors.

The above discussion of documents, acts, materials, devices, articles and the like is included in the specification for the purpose of providing a context for the present invention. It is not suggested or represented that any or all of these matters formed part of the prior art base or were common general knowledge in the field relevant to the present invention as it existed before the priory date of each claim in this application.

### SUMMARY OF INVENTION

One aspect of the present invention comprises a controller for controlling a pump unit comprising an electric motor for moving fluid in a hydraulic application, the controller comprising a memory and a processor implementing a determination module configured to: receive a voltage value from the electric motor of the pump unit; receive a current value from the electric motor of the pump unit; receive a speed of rotation of the electric motor of the pump unit; and predict at least one of a pressure and a flow of the pump unit based on the voltage value, the current value and the speed of rotation, wherein the controller is configured to control the pump unit according to at least one of the predicted pressure and the predicted flow of the pump unit.

Preferably, the controller controls the electric motor of the pump unit to control movement of the fluid by the pump unit in the hydraulic application. It will be appreciated by those persons skilled in the art that the determination module is implemented by program code stored on the memory that is implemented by the processor of the controller. The controller may also implement other modules to control the pump unit, such as a module configured to set to the electric motor to run at a certain speed or a module to utilize available power (e.g., from solar panels) rather than being set at a specific pressure and or flow level.

In this preferred form, such a pump unit will advantageously be as described in the applicant's co-pending International patent application titled “An Axial-Flow Centrifugal Hydraulic Pump”. The pump unit may be used in a pool skimming system of the type described in the applicant's co-pending International patent application titled “Back-flushing Pool Skimming System”, both being lodged on the same day as this present application. The content of both of these co-pending patent applications is herein incorporated by reference.

The hydraulic application may be recirculating hydraulic system, such as a pool, spa or other body of water. As mentioned, pools have a specified turnover rate of at least one complete volume of pool water per 24 hours and flow rate can be used to make this determination.

In an embodiment, the determination module is configured to receive a pump performance curve of the pump unit from the memory, the pump performance curve comprising a designated operating region of pressure and flow of the pump unit for a designated range of speeds of rotation of the electric motor.

It will be appreciated by those persons skilled in the art that a pump performance curve is normally provided by a manufacturer of a pump unit and describes the relationship between the flow and the head pressure for the pump unit.

Alternatively, the pump performance curve can be determined by empirical testing of the pump unit.

In an embodiment, the pump unit has a variable speed electric motor and the pump performance curve thus comprises pressure relative to flow, power relative to flow, and speed relative to flow for the pump unit. It will be also appreciated that the pump performance curve can be represented as equations or a table of values. The equation-based approach can be manipulated using “Pump Affinity Laws”, which are known physical characteristics of pumping systems, where the hydraulic outcome can be calculated from a change of inputs such as power. A table of values can be used to cover the performance range of the pump, and a “closest match” method used to determine flow and pressure from the predicted pressure and or flow.

In an embodiment, the determination module is configured to determine a power draw of the electric motor of the pump unit from the voltage value and the current value, and to predict the pressure and or the flow of the pump unit by applying the power draw and the speed of rotation to the pump performance curve.

In an embodiment, the determination module is configured to determine whether the pump unit is operating in the designated operating region in the pump performance curve according to at least one of the predicted pressure and the predicted flow of the pump unit.

In an embodiment, the determination module is configured to determine whether the pump unit is in a fault condition if the pump unit is determined as operating outside the designated operating region in the pump performance curve. That is, a change in predicted pressure and or flow may be indicative of a fault condition. The change in predicted pressure and or flow may also be indicative of the pump unit achieving a goal such as returning to the target designated operating region.

In an embodiment, the determination module is configured to determine whether the pump unit is moving towards a fault condition if the pump unit is determined as operating inside the designated operating region in the pump performance curve and trending towards a boundary of the designated operating region over a designated time.

In an embodiment, the controller is configured to output the fault condition and whether the pump unit is moving towards the fault condition to a display associated with the pump unit. For example, the controller is configured to output an alert of the fault condition and whether the pump unit is moving towards a fault condition to a user device in data communication with the controller.

In an embodiment, the controller is configured to control the electric motor of the pump unit in response to the fault condition and or the pump unit moving towards the fault condition. For example, the controller is configured to control the electric motor by one or more of: turning OFF of the electric motor; varying the speed of rotation of the electric motor; reversing a direction of rotation of the electric motor and entering a test mode of the electric motor.

In an embodiment, the hydraulic application is a fixed pressure hydraulic application where pressure of fluid in the hydraulic application is maintained at a set pressure range by the pump unit, and the controller is configured to turn OFF the electric motor to maintain the pressure of the fluid in the hydraulic application at the set pressure range according to the predicted pressure.

In an embodiment, the hydraulic application is a fixed pressure hydraulic application where pressure of the fluid in the hydraulic application is maintained at a set pressure range by the pump unit, and the controller is configured to vary the speed of rotation of the electric motor to maintain the pressure of the fluid in the hydraulic application at the set pressure range according to the predicted pressure.

In an embodiment, the hydraulic application is a fixed flow hydraulic application where flow of the fluid in the hydraulic application is maintained at a set flow rate range by the pump unit, and the controller is configured to vary the speed of rotation of the electric motor to maintain the flow rate of the fluid in the hydraulic application at the set flow rate range according to the predicted flow.

In an embodiment, the hydraulic application is a recirculating hydraulic system comprising a turnover rate for a designated volume of fluid in the hydraulic system to be recirculated, and the determination module is configured to determine whether the pump unit has moved the designated volume of fluid in the hydraulic system within a designated time according to the predicted flow. As mentioned above, the recirculating hydraulic system may be a pool, spa, or other body of water. Alternatively, the hydraulic system comprises a hydraulic transfer system.

In an embodiment, the determination module is configured to predict the pressure and or the flow using a multiple regression linear model generated from the voltage value, the current value and the speed of rotation across the pump performance curve. Alternatively, the determination module is configured to predict the pressure and or the flow using a random forest model or a gradient boosting model. In use, however, the multiple regression linear model has been more found to be more efficient than these models.

The determination module may be configured to predict the pressure using a further multiple regression linear model generated from the voltage value, the current value, the speed of rotation, and the predicted flow of the pump unit. The determination module may also be configured to predict the flow using a further multiple regression linear model generated from the voltage value, the current value, the speed of rotation, and the predicted pressure of the pump unit.

In an embodiment, the determination module is configured to apply the multiple regression linear model to solve equations:

H=a+V×b+A×c+RPM×d+V²×e+V×A×f+V×RPM×g+A²×h+A²×RPM×i+RPM²×j

Q=k+V×l+A×m+RPM×n+V²×o+V×A×p+V×RPM×q+A²×p+A×RPM×r+RPM²×s
where:
H is predicted pressure
V is electric motor voltage
A is electric motor current
RPM is the speed of rotation
Q is predicted flow
a−s are pump-specific coefficients.

In an embodiment, the electric motor comprises a brushless DC electric motor. The controller is configured to determine the speed of rotation from a back electromotive force (EMF) signal of the brushless DC (BLDC) electric motor.

In an embodiment, the controller further comprises a BLDC controller module configured to control the BLDC electric motor according to according to the predicted pressure and or the predicted flow of the pump unit. The controller receives the voltage value, the current value and the speed of rotation of the electric motor from the BLDC controller module.

In another embodiment, the electric motor controller comprises an AC electric motor and the controller comprises a Variable Frequency Drive module configured to control the AC electric motor according to the predicted pressure and or the predicted flow of the pump unit.

In an embodiment, the determination module is configured to a determine a designated operating region of pressure and flow of the pump unit based on the current value from the electric motor of the pump unit indicating limits of the designated operating region.

The determination module may then be configured to determine whether the pump unit is in a fault condition if the pump unit is determined as operating outside the designated operating region. The determination module may also be configured to determine whether the pump unit is moving towards the fault condition if the pump unit is determined as operating inside the designated operating region and trending towards a boundary of the designated operating region over a designated time.

The controller may be configured to output the fault condition and whether the pump unit is moving towards the fault condition to a display associated with the pump unit. The controller may also be configured to output an alert of the fault condition and whether the pump unit is moving towards a fault condition to a user device in data communication with the controller.

In an embodiment, the controller is also configured to control the electric motor of the pump unit in response to the fault condition and or the pump unit moving towards the fault condition.

In an embodiment, the voltage is fixed, and the determination module is configured to predict the pressure and or the flow using the current value.

For example, the electric motor is an AC electric motor with unknown pump characteristics, with a fixed frequency and voltage of the AC power input, Accordingly, the controller provides fault detection and pump protection of the AC electric motor pump with unknown characteristics without flow intrusion with a sensor.

### BRIEF DESCRIPTION OF DRAWINGS

Embodiments of the present invention will now be described in greater detail with reference to the accompanying drawings, in which:

FIG. 1 is a schematic diagram of a system comprising a controller for controlling movement of fluid in an aquatic application according to an embodiment of the present invention;

FIG. 2 is section view of a pump unit showing a direction of flow of fluid through the pump unit according to an embodiment of the present invention; and

FIG. 3 is an exemplary graph of flow versus pressure of a pump unit according to an embodiment of the present invention.

### DETAILED DESCRIPTION

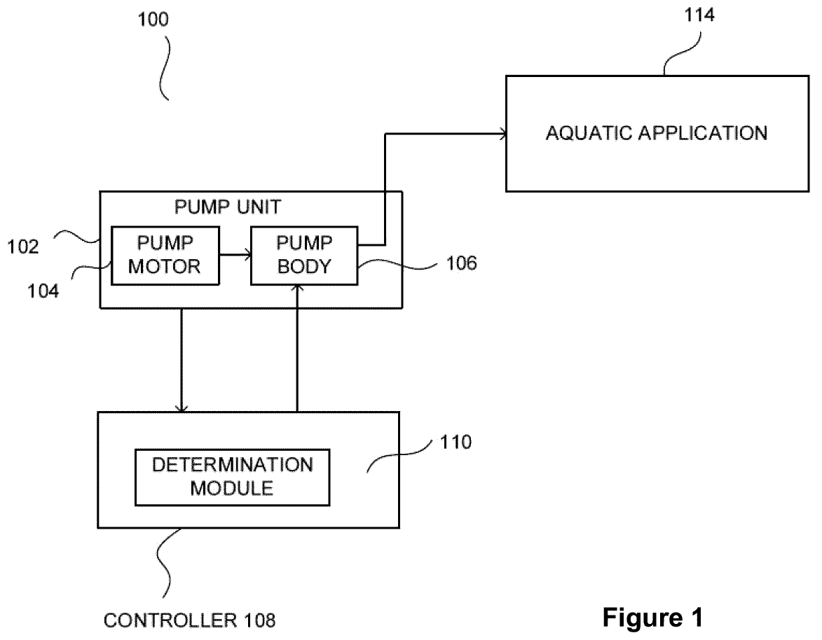

FIG. 1 shows a schematic diagram of a system 100 for controlling movement of fluid in an aquatic application according to an embodiment of the present invention. The system 100 comprises a pump unit 102 communicatively coupled to a controller 108. The controller 108 is configured to control movement of fluid in an aquatic application 114.

The fluid in one or more embodiments of the invention is water. Aquatic application 114 may be a swimming pool, a spa, or aquaculture etc. Furthermore, movement of the fluid may refer to recirculation of the fluid within the aquatic application or transfer of fluid to/from the aquatic application.

The pump unit 102 comprises a pump motor 104 and a pump body 106. In one or more embodiments, the pump motor 104 is a brushless DC (“BLDC”) electric motor. In the smaller power sizes, e.g., up to approximately 2.2 kw, a BLDC motor may be significantly more efficient than a traditional AC induction electric motors. Typically, a BLDC motor is 80 to 90% efficient while an AC induction motor is 30-50% efficient.

This type of electric motor can also be considered as an “Electronic” motor, as without a “PWM” Pulse Width Modulation signal and a dedicated controller these motors will not spin/rotate at all. The pump motor 104 is connected to the pump body 106 and together function as a pump unit 102 that is communicatively coupled to the controller 108 for controlling movement of the fluid in the aquatic application 114.

In another embodiment, the pump motor 104 is an AC motor and the controller 108 comprises a Variable Frequency Drive module to control the AC motor.

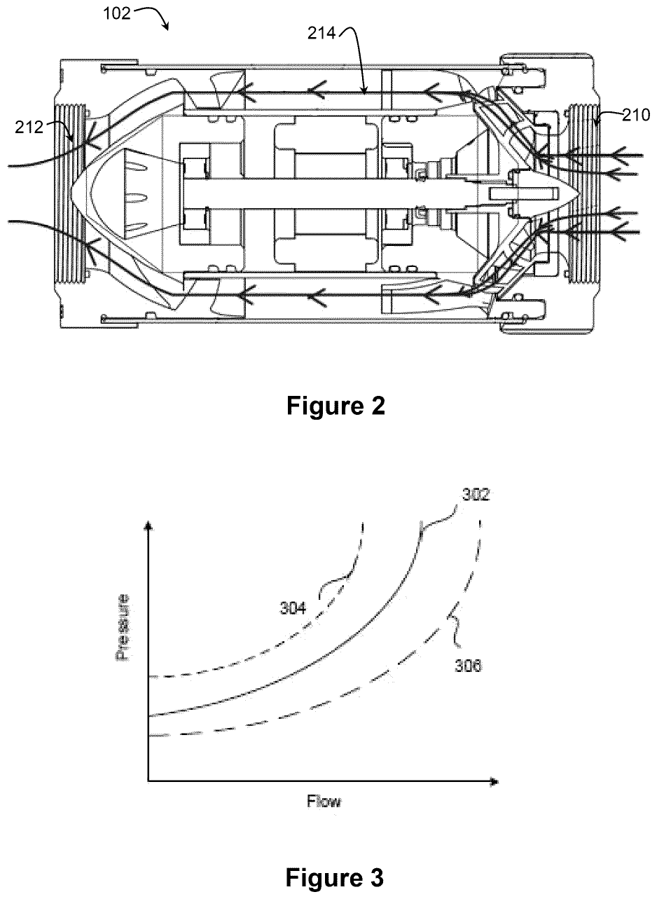

An exemplary embodiment of an in-line, axial-flow centrifugal hydraulic pump unit 102 is shown in FIG. 2. The pump unit 102 comprises an axially extending pump body 106 having an inlet 210 at one end of the pump body 106 and an outlet 212 at an opposed end of the pump body 106. The pump body 106 is cylindrical in shape and houses a cylindrically shaped pump motor 104 (e.g., a direct current (DC) electric motor) centrally within the pump body 106 between the inlet 210 and the outlet 212 of the pump unit 102. The fluid flows through the pump unit 102 in a direction as shown by lines 214. In the embodiment, the pump unit 102 is used for recirculating and filtering water in a swimming pool or spa. However, it will be appreciated that other designs and/or configurations of the pump unit 102 may be possible without departing from the scope of the present invention.

The controller 108 further comprises a determination module 110 that receives a voltage value from the pump unit 102 and a current value from the pump unit. It will be appreciated that the voltage value of the pump unit 102 using the BLDC motor is a DC voltage value (V) and the current value (A) is a DC current value. Based on the received voltage value and the received current value, the power (W) consumed by the pump is calculated as follows:

W=V*A Equation (1)

The determination module 110 further estimates a speed of rotation of the pump unit 102 (i.e. speed of rotation of the pump motor 104 within the pump unit 102 in revolutions per minute). It will be appreciated that the speed of rotation of the pump motor 104 is governed by the resistive torque on the shaft of the pump motor 104. For a BLDC motor driving a pump impeller—for a given fluid (for example, water)—the torque is a function of the hydraulic system the pump unit 102 is operating within (for a given power, torque is a function of the flow and pressure the impeller is generating, via the driving electric motor i.e., the pump motor 104).

The estimation of speed of rotation of the pump unit 102 (i.e., speed of rotation of the pump motor 104 within the pump unit 102 in revolutions per minute) may be based on a natural back electromotive force (“EMF”) signal provided by the driven pump motor 104 back to the controller 108 or using Hall effect sensors. A hall effect sensor detects the presence and magnitude of a magnetic field, and the resulting signal can be analysed to calculate motor speed. Hall Effect sensors requires dedicated wiring to return the signal to the controller, providing a potential additional failure point for a submerged application.

The determination module 110 then predicts flow and or pressure of the pump unit 102, based on the received voltage value, the received current value and the estimated speed of rotation. Prediction may be done using a performance curve of the pump unit 102 or a multiple regression linear model as will be discussed in more detail below.

The controller 108 then controls movement of the fluid by the pump unit 102 in the aquatic application 114 according to the predicted flow and or pressure.

In one or more embodiments, one or more of the voltage value, current value and speed of rotation may be variable, i.e., one or both of the power (derived based on the received voltage value and the received current value based on equation (1)), and speed of rotation of the pump unit 102 may be variable.

In one or more embodiments, when both the voltage value and the current value to the pump unit 102 are fixed, the power supply to the pump unit 102 is fixed. Power supply can be at specific/numerous “power bands” (for example, fixed power at 100 Watts, 120 Watts, 300 Watts and so on). This can be a function of the controller 108.

For each power band, the hydraulic characteristics of flow and pressure are directly relational to varying speed.

For a specific pump model, this relationship between speed, flow and pressure can be defined for a power band. Numerous power bands can be defined to cover operational performance of the pump unit 102.

When the speed of rotation is variable and the power is within one of a plurality of fixed power bands, the determination module 110 is configured to determine the pressure and/or the flow based on the speed of rotation and a model of the pump, for a corresponding one of the plurality of fixed power bands.

In other words, for a given power band, the flow and/or pressure can be predicted from the known inputs of power and speed.

In some other embodiments, the speed of rotation may be fixed while the power supplied to the pump unit 102 variable (due to varying voltage value or varying current value). The speed of rotation can be set at numerous “speed bands” (for example, fixed speed at 1500 RPM, 2000 RPM, 3000 RPM and so on). This can be a function of the controller 108.

For each speed band, the hydraulic characteristics of flow and pressure are directly relational to varying power consumption of the pump unit 102.

For a specific pump model, this relationship between power, flow and pressure can be defined for a speed band. Numerous speed bands can be defined to cover operational performance of the pump unit 102.

When the power consumed by the pump unit 102 is variable and the speed of rotation is within one of a plurality of fixed speed bands, the determination module 110 is configured to predict the pressure and/or the flow based on the power (determined based on the received voltage value and the received current value) and a model of the pump, for a corresponding one of the plurality of fixed speed bands.

In other words, for a given speed band, the flow and/or pressure can be predicted from the known inputs of power and speed.

### Empirical Testing to Determine Pump Characteristics Over Operational Range

As mentioned, a pump performance curve is normally provided by a manufacturer of a pump unit and describes the relationship between the flow and the head pressure for the pump unit.

It will be appreciated, however, that the performance curve for a given model of pump unit 102 over its operational range can be derived from empirical testing as will be explained in more detail below.

Pumps are tested using third party (calibrated) sensors for flow and pressure, and back EMF for speed to determine its performance characteristics, thus defining the operational/performance curve of the pump for a nominal power band.

Typically, testing follows ISO 99909 2018 standard. For nominal starting power, the performance curve is determined by varying the backpressure of the system from fully open to fully closed across several (approximately 10) sample points, and for each sample point, flow (Q), pressure (H), power (W) and speed of rotation (RPM) are measured. The physical characteristics of a hydraulic system mean the relationship between each of Q to H, Q to Wand Q to RPM can be defined as a polynomial equation (typically a 3^{rd} degree polynomial, but it some cases more complex) in the form of:

H=a×Q3+b×Q2+c Equation (2)

W=d×Q3+e×Q2+f Equation (3)

RPM=g×Q3+h×Q2+I Equation (4)

A highly granular lookup table of parameters can be built using the above polynomial equations.

Empirical testing is conducted across nominal power and the above process is followed to determine an acceptable accuracy coverage over the performance range of the pump unit 102. These additional nominal power outcomes can be derived using pump affinity laws.

Once an acceptable (determined by accuracy requirements) data is achieved, all test results are combined to create a Lookup Table in the following format:

| | | | | | |
|---|---|---|---|---|---|
| Test ID | Q | W | RPM | H | RPMVarCalc |

Accordingly, the flow can be determined from the created lookup table once the speed of rotation is received from the controller and the power is calculated (based on the received voltage value and the received current value (using equation (1)).

Furthermore, potential values of flow, pressure, and speed of rotation can be predicted within a nominated percentage of the read power of the pump unit 102. Similarly, potential values of flow, pressure, and power can be predicted within a nominated percentage of the read speed of rotation.

An exemplary embodiment is provided below for determining the flow (Q) and pressure (H) of a pump unit 102 when the power (W) consumed by the pump unit is determined to be 248 W (+/−1%) and the speed of rotation (RPM) is estimated to be 1850 rpm.

An exemplary lookup table may be as follows where power (W)=230 W+/−1% (8 rows). The fidelity of the data set in the lookup table will inform the nominated percentage—the more extensive the dataset, the better the expected accuracy, but the more memory/power is required for calculation.

TABLE 1

| Test ID | Q | W | RPM | H | RPMVarCalc |
|---|---|---|---|---|---|
| 40 | 220 | 245. 8938 | 1877. 817 | 3. 074982 | 28 |
| 40 | 225 | 247. 1782 | 1874. 366 | 3. 038099 | 24 |
| 40 | 230 | 248. 4154 | 1871. 048 | 3. 001138 | 21 |
| 40 | 235 | 249. 6047 | 1867. 864 | 2. 964092 | 18 |
| 41 | 110 | 247. 3671 | 2140. 361 | 4. 430556 | 290 |
| 41 | 115 | 249. 852 | 2134. 728 | 4. 389259 | 285 |
| 42 | 50 | 246. 0556 | 2341. 571 | 5. 383605 | 492 |
| 42 | 55 | 249. 0906 | 2333. 704 | 5. 339231 | 484 |

The controller 108 will determine the highlighted row to have the closest speed of rotation to the dataset with a variation in calculated RPM (“RPMVarCalc”) of 18 rpm. Accordingly, the controller 108 will predict the flow and pressure of the pump unit to be Q=235 lpm and H=2. 96.

### Prediction Using Performance Curve

A hydraulic system curve defines the relationship between changing flow and pressure. As flow increases in a given hydraulic system (i.e., velocity increases) additional energy is required to overcome the kinetic energy lost (friction of the fluid). This relationship is fixed for a given hydraulic system (provided there are no changes in other operating conditions of the pump unit 102) and can be mathematically defined (parabolic formula) by readings of flow and pressure and different points on the system curve. That is, the velocity/pressure relationship, as defined by the parabolic curve, is fixed, and can be calculated as long as conditions of the hydraulic system do not change, for example by an increasingly blocked filter.

FIG. 3 is an exemplary graph of flow versus pressure of a pump unit 102 showing a normal performance curve 302 as well as curves 304, 306 when the operating conditions of the pump unit 102 are not normal i.e., changed conditions.

The performance curve can be defined as follows:

Pressure=a×Flow\hat{ }2+b×Flow+c Equation (5)

where a, b and c are constants specific to the application's system curve. From a set of sample points, a, b and c can be calculated using quadratic regression by the controller 108.

For example, Pressure=0.215121×Flow\hat{ }2+0×Flow+1. The constants are derived using regression technique applied to a sample set of data (test data) and are specific to a pump model.

The same relationship holds true for the relationship between power (W), flow and pressure, as defined by the following equations:

Flow=d*W\hat{ }2+e*W+f Equation (6)

Pressure=g×W\hat{ }2+h*W+i Equation (7)

where constants d, e, f, g, h, i can be derived using regression from a sample data set by the controller 108. These constants are also derived using regression technique applied to a sample set of data (test data) and are specific to a pump model.

Accordingly, flow and pressure can be predicted from power alone. It will be appreciated that this approach is applicable for a static hydraulic system where conditions of flow and pressure do not change. A possible advantage of this approach is that prediction of flow and pressure is simple and more accurate than the conventional methods. A swimming pool system where a filter will add increasing backpressure over time as it becomes blocked would require redefinition of the system curve over time. In other words, a calibration of the current system curve could occur daily.

### Prediction Using a Multiple Regression Linear Model

In some embodiments, the controller 108 is configured to predict the flow and pressure using a multiple regression linear model generated based on the one or more of the received voltage value, the received current value and the estimated speed of rotation across a performance range for the pump unit. In simple operation, the model is not adjusted, the constants in the equations are fixed for a specific pump. The Input values of Volts, Amps, RPM are applied to the equations to prediction flow and pressure. In further operation, different constants (same equations) can be determined from testing for different operating (power) ranges of the pump unit (and swapped by the controller). This is a refinement of the simple operation to increase accuracy.

In some other embodiments, the controller 108 is configured to predict the flow and pressure using a multiple regression linear model generated based on the one or more of the received voltage value, the received current value, the estimated speed of rotation and a predicted flow or pressure of the pump unit 102. Because there is a fixed and known relationship between Flow and Pressure for a given pump unit, if we can accurately predict, for example, flow from the model, this can be applied to the known Flow/Pressure model to predict pressure (rather than both being a result of the prediction process).

### Identification and Response to Pump Faults or Failure Conditions

By being able to predict flow and pressure without sensors, one or more embodiments of the present invention can directly understand where a pump unit 102 is operating on its performance curve and identify if the pump unit is in (or moving towards) a fault condition.

Typical water pump unit fault conditions that can be identified by one or more of the embodiments of the present invention without the need for expensive flow, pressure or fault sensors may be summarised as follows:

TABLE 2

| Ref | Fault | Condition | Outcome | Result |
|---|---|---|---|---|
| 1 | Loss of prime | No water in | Run dry | Mechanical seal |
| | | pump | | failure |
| 2 | Blocked | Little to no | Cavitation | Above plus motor |
| | suction | water in pump | | bearings |
| 3 | Closed suction | Pump starved | Cavitation | As above |
| | valve | of water | | |
| 4 | Closed | Pump operating | Boil | If a plastic, melt |
| | discharge | at shut-off | | down of |
| | valve | head | | components, plus |
| | | | | above |
| 5 | Open | Pump operating | Burst pipe | Huge waste of |
| | discharge | off end of | | water. Will drain |
| | | curve | | tank then, ref 1 |
| 6 | Noisy | All of the | Failed Mech | Annoying to |
| | | above | Seal and or | owners and |
| | | | motor | neighbours, then |
| | | | bearings | costly due to |
| | | | | total replacement |

In some embodiments, the predicted flow and pressure and/or fault conditions can be reported via Wi-Fi or any other suitable communication channels and the internet onto a remote device (such as a mobile phone) to keep the pump owners, not only fully informed on pump unit/filtration performance, but also to allow to conduct self-diagnosis to identify potential failure, stop and report. In some embodiments, a report may be generated to a nominated third-party repair/maintenance service provider.

For example, the hydraulic application, otherwise referred to as a hydraulic system is considered to be in a satisfactory state for a given pressure and/or flow range. If predicted flow and/or pressure falls out of the acceptable range of the pump performance range, the system can be considered to be in fault, and the pump unit could be stopped and/or alert provided. A specific use case is detecting a burst pipe in the hydraulic system. In this use case, an increase in flow (decrease in pressure) would fall outside of a predefined acceptable range of the pump performance range and the pump unit will be shut down and/or an alert activated.

Additionally, the instantaneous flow and pressure predictions can be assessed over time to identify changes in hydraulic system, or the achievement of a predefined goal. An example of this is in a pool pump/water treatment installation, where the pump is pushing water through a filter. As the filter becomes blocked over time, the pressure rises over time until the pressure reaches a predetermined level. At this time an alert can be activated. This can be differentiated from a sudden change in the system (such as the burst pipe scenario described) where the pump unit is shot down.

Additionally—the instantaneous flow prediction can be accumulated over time to provide a predicted volume pumped over the period of time. An example is filling a 10,000 Litre water tank with the pump unit. The flow rate can be calculated as a volume over the sampling rate, and this volume can be totalised over the operating period until it reaches the predetermined volume (10,000 L). The pump unit can then be turned off and/or alert sent.

### Empirical Testing to Determine Pump Characteristics Over Operational Range of an AC Pump

As mentioned, the pump motor 104 may be an AC electric motor, such as a typical mains AC power pump. The AC electric pump motor 104 has a fixed voltage and a fixed frequency AC power supply. As voltage is fixed, current draw of the pump motor 104 is the only variable. If the pump characteristics of the pump motor 104 are unknown, the determination module 110 can determine a designated operating region of pressure and flow of the pump unit 102 based on the current value from the electric motor 104 indicating the limits of the designated operating region.

The designated operating region may be determined based on the limits of the designated operating region by the current value from the electric motor 104 of the pump unit 102 at the limits of the designated operating region. The determination module 110 receives the current values received at these limits. These limits are at full open flow of the pump unit 102 and zero flow/closed discharge of the pump unit 102. If the pump is a pump with known pump characteristics, the pump performance curve could be used to inform the limits.

The determination module may then be configured to determine whether the pump unit is in a fault condition if the pump unit is determined as operating outside the designated operating region or moving towards the fault condition if the pump unit is determined as operating inside the designated operating region and trending towards a boundary of the designated operating region over a designated time.

The controller may be configured to output the fault condition and whether the pump unit is moving towards the fault condition to a display associated with the pump unit or a user device in data communication with the controller.

Further, the controller is also configured to control the electric motor of the pump unit in response to the fault condition and or the pump unit moving towards the fault condition. Accordingly, the controller provides sensorless control of the pump unit.

Where any or all of the terms “comprise”, “comprises”, “comprised” or “comprising” are used in this specification (including the claims), they are to be interpreted as specifying the presence of the stated features, integers, steps or components, but not precluding the presence of one or more other features, integers, steps or components.

It is to be understood that various alterations, additions and/or modification may be made to the parts previously described with departing from the ambit of the present invention.

1. A controller for controlling a pump unit comprising an electric motor for moving fluid in a hydraulic application, the controller comprising a memory and a processor implementing a determination module configured to:
receive a voltage value from the electric motor of the pump unit;
receive a current value from the electric motor of the pump unit;
receive a speed of rotation of the electric motor of the pump unit; and
predict at least one of a pressure and a flow of the pump unit based on the voltage value, the current value and the speed of rotation,
wherein the controller is configured to control the pump unit according to at least one of the predicted pressure and the predicted flow of the pump unit.

2. The controller according to claim 1, wherein the determination module is configured to receive a pump performance curve of the pump unit from the memory, the pump performance curve comprising a designated operating region of pressure and flow of the pump unit for a designated range of speeds of rotation of the electric motor.

3. The controller according to claim 2, wherein the determination module is configured to determine a power draw of the electric motor of the pump unit from the voltage value and the current value, and to predict the pressure and or the flow of the pump unit by applying the power draw and the speed of rotation to the pump performance curve.

4. The controller according to claim 3, wherein the determination module is configured to determine whether the pump unit is operating in the designated operating region in the pump performance curve according to at least one of the predicted pressure and the predicted flow of the pump unit.

5. The controller according to claim 4, wherein the determination module is configured to determine whether the pump unit is in a fault condition if the pump unit is determined as operating outside the designated operating region in the pump performance curve.

6. The controller according to claim 5, wherein the determination module is configured to determine whether the pump unit is moving towards a fault condition if the pump unit is determined as operating inside the designated operating region in the pump performance curve and trending towards a boundary of the designated operating region over a designated time.

7. The controller according to claim 6, wherein the controller is configured to output the fault condition and whether the pump unit is moving towards the fault condition to a display associated with the pump unit.

8. The controller according to claim 7, wherein the controller is configured to output an alert of the fault condition and whether the pump unit is moving towards a fault condition to a user device in data communication with the controller.

9. The controller according to claim 6, wherein the controller is configured to control the electric motor of the pump unit in response to the fault condition and or the pump unit moving towards the fault condition.

10. The controller according to claim 9, wherein the controller is configured to control the electric motor by one or more of: turning OFF of the electric motor; varying the speed of rotation of the electric motor; reversing a direction of rotation of the electric motor and entering a test mode of the electric motor.

11. The controller according to claim 1, wherein the hydraulic application is a fixed pressure hydraulic application where pressure of fluid in the hydraulic application is maintained at a set pressure range by the pump unit, and the controller is configured to turn OFF the electric motor to maintain the pressure of the fluid in the hydraulic application at the set pressure range according to the predicted pressure.

12. The controller according to claim 1, wherein the hydraulic application is a fixed pressure hydraulic application where pressure of the fluid in the hydraulic application is maintained at a set pressure range by the pump unit, and the controller is configured to vary the speed of rotation of the electric motor to maintain the pressure of the fluid in the hydraulic application at the set pressure range according to the predicted pressure.

13. The controller according to claim 1, wherein the hydraulic application is a fixed flow hydraulic application where flow of the fluid in the hydraulic application is maintained at a set flow rate range by the pump unit, and the controller is configured to vary the speed of rotation of the electric motor to maintain the flow rate of the fluid in the hydraulic application at the set flow rate range according to the predicted flow.

14. The controller according to claim 1, wherein the hydraulic application is a recirculating hydraulic system comprising a turnover rate for a designated volume of fluid in the hydraulic system to be recirculated, and the determination module is configured to determine whether the pump unit has moved the designated volume of fluid in the hydraulic system within a designated time according to the predicted flow.

15. The controller according to claim 14, wherein the recirculating hydraulic system is a pool, spa, or other body of water.

16. The controller according to claim 2, wherein the determination module is configured to predict the pressure and or the flow using a multiple regression linear model generated from the voltage value, the current value and the speed of rotation across the pump performance curve.

17. The controller according to claim 16, wherein the determination module is configured to predict the pressure using a further multiple regression linear model generated from the voltage value, the current value, the speed of rotation, and the predicted flow of the pump unit.

18. The controller according to claim 17, wherein the determination module is configured to predict the flow using a further multiple regression linear model generated from the voltage value, the current value, the speed of rotation, and the predicted pressure of the pump unit.

19. The controller according to claim 18, wherein the determination module is configured to apply the multiple regression linear model to solve equations:
H=a+V×b+A×c+RPM×d+V²×e+V×A×f+V×RPM×g+A²×h+A×RPM×i+RPM²×j
Q=k+V×l+Ax m+RPM×n+V²×o+V×A×p+V×RPM×q+A²×p+A×RPM×r+RPM²×s
where:
H is predicted pressure
V is electric motor voltage
A is electric motor current
RPM is the speed of rotation
Q is predicted flow
a−s are pump-specific coefficients.

20. (canceled)

21. The controller according to claim 1, wherein the electric motor comprises a brushless DC electric motor, wherein the controller is configured to determine the speed of rotation from a back electromotive force (EMF) signal of the brushless DC (BLDC) electric motor, and wherein the controller further comprises a BLDC controller module configured to control the BLDC electric motor according to according to the predicted pressure and or the predicted flow of the pump unit.

22.-31. (canceled)
